(19) United States
(12) Patent Application Publication
(10) Pub. No.: US 2017/0244177 A1
(43) Pub. Date: Aug. 24, 2017

(54) Broadband Dual Linear Cross Polarization Antenna

(71) Applicant: George Samuel, Grand Prairie, TX (US)

(72) Inventor: George Samuel, Grand Prairie, TX (US)

(21) Appl. No.: 15/156,023

(22) Filed: May 16, 2016

Related U.S. Application Data
(60) Provisional application No. 62/162,398, filed on May 15, 2015.

(51) Int. Cl. H01Q 25/00; H01Q 1/24; H01Q 1/48

(52) U.S. Cl. CPC H01Q 25/001; H01Q 1/48; H01Q 1/245

(57) ABSTRACT

A broadband dual linear cross polarization antenna is provided having a horizontally disposed ground plane on which a first dielectric notch antenna and a second dielectric notch antenna extend from engagements thereto. A pair of vertically ground planes are engaged with and extend from opposite ends of the horizontally disposed ground plane.

### BACKGROUND OF THE INVENTION

### 1. Field of the Invention

This application claims priority to U.S. Provisional Patent Application Ser. No. 62/162398 filed on May 15, 2015, which is incorporated herein in its entirety by this reference thereto.

The present invention relates to antennas employed for radio frequency communications such as cellular systems. More particularly, it relates to a broadband dual linear cross polarization antenna element formed to an array thereof featuring a plurality of such elements positioned in combination with bottom and/or side ground planes to yield an especially effective array adapted for broadband communications.

### 2. Prior Art

Conventionally, antennas are formed in a structure that may be adjustable for frequency and gain by changing the formed structural elements. Shorter elements for higher frequencies, longer elements for lower, and pluralities of similar elements to increase gain. However, the formed antenna structure itself is generally fixed but for elements that may be adjusted for length or angle to better transmit and receive on a frequency.

As such, when constructing a communications array such as a cellular antenna grid, or a wireless communications web, the builder is faced with the dilemma of obtaining antennas which are constructed for the frequencies required for the job at hand from suppliers. Most such antennas are designed and manufactured to primarily match the frequencies to be employed at the transmission site, which can vary widely depending on the network and venue.

Also, a horizontal, vertical, or circular RF polarization scheme may be desired to either increase bandwidth or to increase the total number of possible individual connections by allowing differing polarizations to communicate through and with the antenna radiator element. Further consideration must be given to the gain at the chosen frequency and thereafter elements included in the final structure to meet the gain requirements and possible beam steering requirements. Polarization is an important design consideration. The polarization of each antenna in a system should be properly aligned. Maximum signal strength between stations occurs when both stations are using identical polarization.

Consequently, with antennas employed in wireless communications, for example such as cellular or grid systems, it is an important consideration as to whether the polarization is linear, elliptical or circular. With antennas situated with direct line-of-sight paths, it is an important consideration that the polarization of the antennas at opposite ends of the RF communication, employ the same polarization. It is well known that in a linear polarized RF system, a misalignment of polarization of 45 degrees will degrade the signal up to 3 dB and if misaligned 90 degrees the signal attenuation can be 20 dB or more. The same is true of circular polarization where mismatched antennas will incur the same degradation of signal.

Cross polarization is another issue system designers must consider. Such occurs when unwanted RF radiation is received by an antenna element from a polarization which is different from the polarization in which the antenna was intended to radiate. Vertical polarized antenna elements may radiate some horizontal polarized signals and horizontally disposed elements may radiate a percentage of signals in a non horizontal polarization. In recent years with the popularization of smartphones which transmit and receive both voice and data, cellular antenna sites are inundated with signals from mobile radios and cellular telephones.

However, the transmitted and received polarization of the RF signals from such handheld smartphones and radios, are often random, or skewed from an exact match between the two. This is because the polarization of the outgoing signal, relative to the receiving antenna, is dependent on how the transmitting user is holding the smartphone or radio. The polarization angle of the RF signal will vary, since the antenna in such smartphones and radios is fixed relative to their housing. While fixed relative to the housing of the phone, the user will generally change the positioning and angle of that housing frequently when talking or inputting data. This occurs when walking and changing directions, changing the phone angle to the head, driving around a curve and in similar instances. Such, of course, produces a cross polarized signal relative to the receiving antenna radiator element which is fixed in position and orientation. This mismatch must be dealt with in order to maintain communications with the remotely held unit.

Currently, such cross polarization issues are handled by system providers through the employment of two antenna elements or radiator elements, where one is fixed in a horizontal polarization disposition and the other in a vertical disposition. However, in such conventional systems, this pseudo array must be linked by dual feed lines with one feed from each antenna being linked to significant active circuitry to deal with the issue of signal phase and mixing of signals. Such are complicated and expensive solutions to the problem and have other issues which must be dealt with due to the need for multiple feeds and the circuitry to mix them.

As such there is a continuing unmet need for an antenna element which is positionable in an array which is simple in construction and capable of achieving cross-polarization of the RF signal, using a single feed line or easily configured dual feed. In this configuration with a single feed, in addition to rendering the array simple, it eliminates the need for active circuitry and circuit boards and power to run such. Such a device would best be modular in nature and allow a high degree of custom configuration for frequency, polarization, gain, and direction, steering and other factors.

### SUMMARY OF THE INVENTION

The device and method herein disclosed and described provides a solution to the shortcomings of the prior art in cross polarized antennas through the provision of uniquely shaped wideband elements as well as a unique positioning and orientation of such elements in combination with a ground plane, which provides a formed antenna capable of achieving cross-polarization. Such is achieved by the antenna herein in a configuration requiring a single feed line and without the need for active circuitry.

In all modes, the device herein, a wideband notch horn antenna, is employed for each of the two radiator elements in the formed array. The RF signal reception and emission capabilities of such wideband notch antennas are described in U.S. Pat. No. 8,063,841 which is made part hereof. However, during experimentation with various configurations of the device herein, it was unexpectedly found that extending the copper or conductive material, forming the radiator element on the side opposite the notch or slot which declines in width, significantly improved the performance of the radiator element when paired with a ground plane connected to the edge of this extended portion.

It was found using notch antennas similar to that of U.S. Pat. No. 8,063,841 when assembled in a pair running at determined angles to each other and engaged with a ground plane, provided improved signal transmission and rejection performance. Unexpectedly, it was found that lengthening the conductor of the radiating element, such that it has a length of between 1.2 and 1.4 the distance of the widest point of a line running along the notched side, and engaging the edge of this lengthened conductor opposite the notched side to a ground plane, provided a significant increase to the shorter version of the radiator element. Further, a particular ratio of a conductor length of 1.3 to 1.4 that of the width of the conductor at the widest point of the notched side, yielded the best results of the improved results. Consequently, the device herein yields enhanced performance using either a shorter or longer radiator element. However, the longer element yields the most significant improvement.

In one mode of the device, the formed array features two wideband high gain notch radiating elements, extending perpendicular from an electric engagement with an underlying planar ground plane element. The radiating elements are positioned where their substrates, and the conductor thereon, run at an angle substantially perpendicular to each other.

In another mode, a pair sidewall ground planes of conductive material extend away from the horizontal ground plane in a direction perpendicular to the planar ground plane element. The sidewalls are positioned to run parallel to each other on opposing edges of the horizontal ground plane and to a rear side of the substrate on which the antenna elements are formed, and facing the side of the substrate where feed lines from each element are positioned. The sidewalls extend a distance from the planar ground plane a distance between 50 to 70% the distance of extension of the length of the radiator element from the horizontal ground plane to the distal end of one lobe. A height of the sidewalls between 60 to 70 percent of the height of the radiator element is particularly favored.

In both modes each notch antenna is capable of achieving cross-polarization and does so using a single feed line and without the need for active circuitry. The mode of the device with the rising conductive sidewalls from the planar ground plane yielded increased efficiency from that with simply a horizontal ground plane, while both provided the utility of a single feed from either antenna element with no need for circuitry to mix multiple signals and maintain such in phase.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

### BRIEF DESCRIPTION OF DRAWING FIGURES

FIG. 1 depicts a plan view showing a favored mode of the wideband high gain dielectric notch antenna element formed by conductive material positioned upon a dielectric substrate.

FIG. 2 depicts a rear view of the device as in FIG. 1 showing the feed line on the rear surface of the substrate and communicating between a pickup and a connector.

FIG. 3 depicts current preferred dimensions of the preferred notch element of FIGS. 1 and 2.

FIG. 4 shows another configuration of the wideband high gain dielectric notch antenna employable with the ground plane configurations herein, which has an overall shorter length.

FIG. 5 shows some preferred dimensions of the notch antenna of FIG. 4, which when employed with the ground plane configurations herein yields enhanced performance.

FIG. 5a is a chart showing measured return and loss of testing of a single dielectric notch antenna element, as configured in FIGS. 1-2, depicting measured Return Loss and Smith Chart for the single element in free space in the 1.7-2.9 Ghz range, and showing good results except for at the edges of the frequency coverage.

FIG. 6 depicts the dielectric notch antenna elements of FIGS. 1 and 2 engaged in a preferred perpendicular positioning upon a horizontal ground plane, formed of conductive material.

FIG. 7 is a chart showing measured return and loss of testing of the device in the configuration of FIG. 6 showing a signal improvement over the mode of FIG. 5a provided by the single horizontal ground plane.

FIG. 8 depicts a plurality of the notch elements of FIG. 1 engaged to extend substantially perpendicular from a planar ground plane and running perpendicular to each other.

FIG. 9 is a view of the device of FIG. 8 from one of the two side edges having perpendicular vertical ground plane sections rising therefrom.

FIG. 10 is a chart showing measured return and loss of testing of a single dielectric notch antenna element as configured in FIGS. 8-9, depicting measured Return Loss and Smith Chart in the 1.7-2.9 Ghz range, and showing the improved performance over that of FIG. 7 which depicted performance of the device as configured in FIG. 6.

FIG. 11 is a top plan view of the dimensions of the device as in FIGS. 8-9.

FIG. 12 depicts the dimensions of the vertical ground plane extending from opposing side edges of the ground plane in FIG. 8-9.

### DETAILED DESCRIPTION OF THE PREFERRED EMBODIMENTS OF THE INVENTION

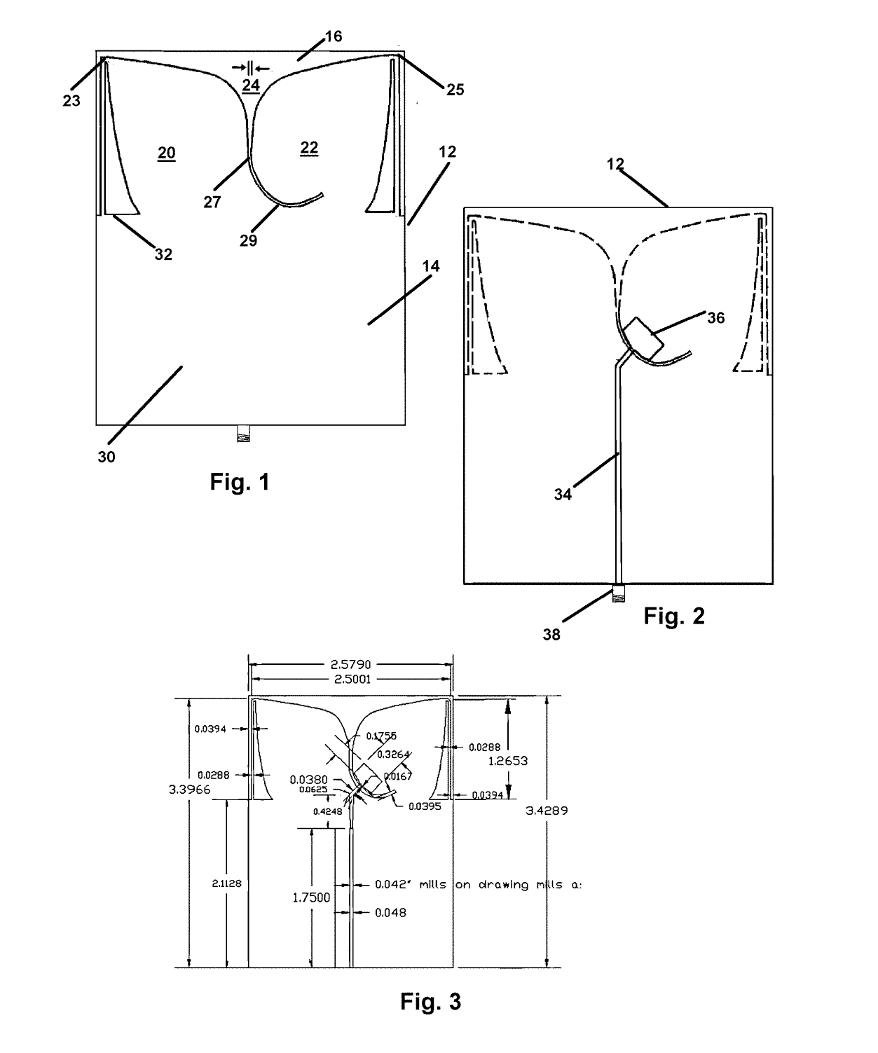

Referring now to the drawings of FIGS. 1-2, in the modes of the device 10 there is seen in FIG. 1 an overhead plan view showing the dielectric notice antenna element 12 formed by conductive material 14 positioned upon a dielectric substrate 16. The conductive material 14 such as copper, forms the antenna element in the shape of a wideband high gain notch antenna. The notch antenna is defined by a first lobe 20 opposite a second lobe 22 having a gap 24 therebetween which declines in cross section from a widest point extending between a first distal end 23 of the first lobe 20 and a second distal 25 end of second lobe 22 to a narrowest point 27 positioned between the two lobes at a point along an imaginary line perpendicular to an imaginary line running between the distal ends 23 and 25 of the first lobe 20 and second lobe 22. A curved portion 29 extends rearward of the narrowest point 27 into one of the two lobes.

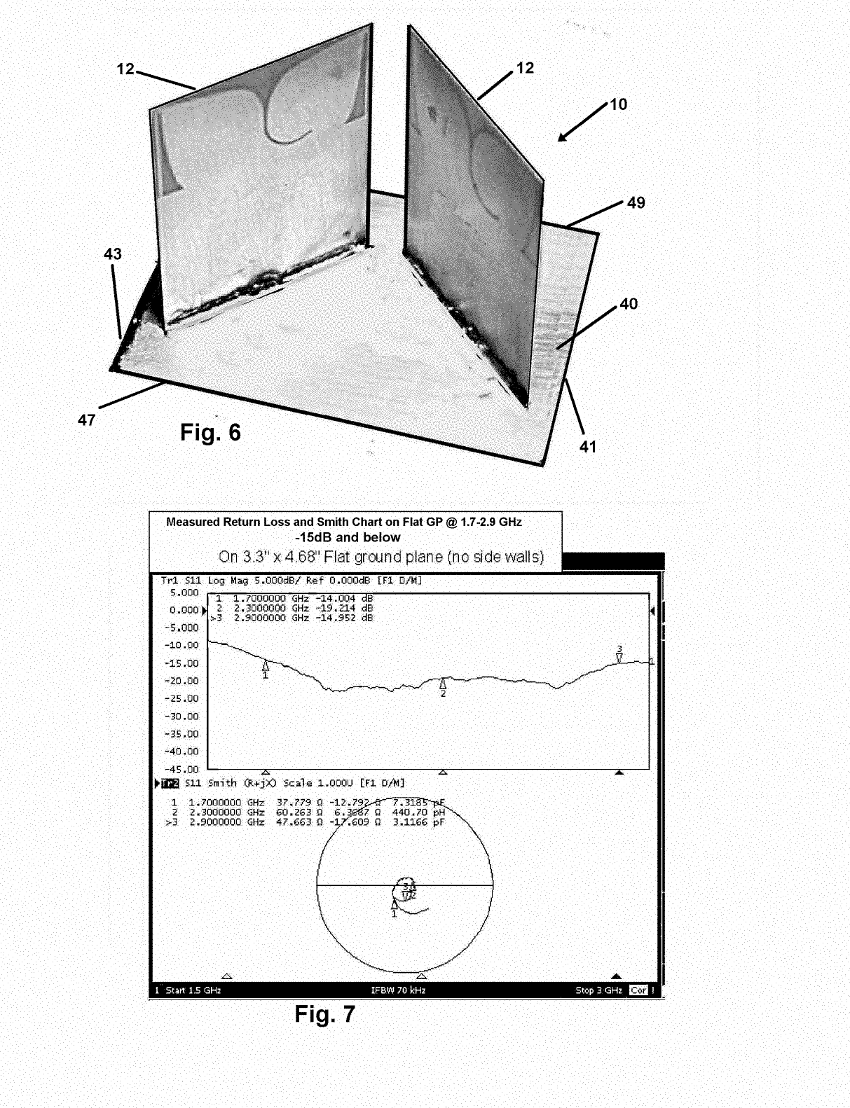

Through experimentation, an especially important component of the dielectric notch antenna 12 in all modes of the device 10 herein, is an extended portion 30 of the conductive material 14 shown in FIG. 1. Absent this extended portion 30 performance of the dielectric notch antenna 12 is substantially less effective when two of the dielectric notch antennas 12 are formed to the broadband dual linear cross polarization antenna as shown in FIGS. 6 and 8-9, upon the ground plane depicted therein.

The extended portion 30 as can be seen extends for a length below the two lobes 20 and 22 for a distance exceeding the height of the lobes 20 and 22 at their distal ends 23 and 25, above a line of separation 32 defined by a linear edge of conductive material 14 on the substrate 16. The total height of the dielectric notch antenna 12 element, runs from the distal ends 23 or 25 of the lobes to a respective opposite corner covered by the conductive portion of the extended portion 30. The total width of the dielectric notch antenna 12 element is considered the distance between the distal ends 23 and 25.

A preferred mode of the device 10 herein may employ two smaller dielectric notch antenna 12 elements, which each have a height of between 1.2 and 1.4 the distance of the width for a smaller dielectric notch antenna 12 element. Engaging the edge of the conductor 30 opposite the notched side of the dielectric notch antenna 12 element to a ground plane 40 as noted, has shown to provide a significant gain in performance. Further, employing a dielectric notch antenna 12 element of a larger configuration such as in FIGS. 1-2, or with a ratio of a conductor height of 1.3 to 1.4 that of the width of the conductor between the distal ends 23 and 25, along the notched side, yielded even more enhanced results. Consequently a dielectric notched antenna 12 or element, in these configurations, is preferred in both modes of engagement to the ground plane 40.

FIG. 2 depicts a rear view of the device 10 as in FIG. 1 showing the feed line 34 on the rear surface of the substrate 16 and communicating between a pickup 36 and a connector 38. The shadow of the lobes 20 and 22 and extended portion 30 through the substrate 16 can be seen.

FIG. 3 as noted, depicts an overhead view of a depiction of currently preferred dimensions of the dielectric notch antenna 12 of FIG. 1 and as used in pairs in the dual linear cross polarization antenna formed in FIGS. 6, 8-9 by two dielectric notch antennas 12 in the angled positioning shown in FIGS. 6 and 8-9 positioned upon a ground plane 40. The antenna so formed and with the noted ratio of extension portion 30 to lobes 20 and 22 noted above performs exceptionally well in frequencies between 1.7 GHz to 2.9 GHz. Of course an adjustment of the widest point shown and narrowest point of the gap 24 can be employed to change this range.

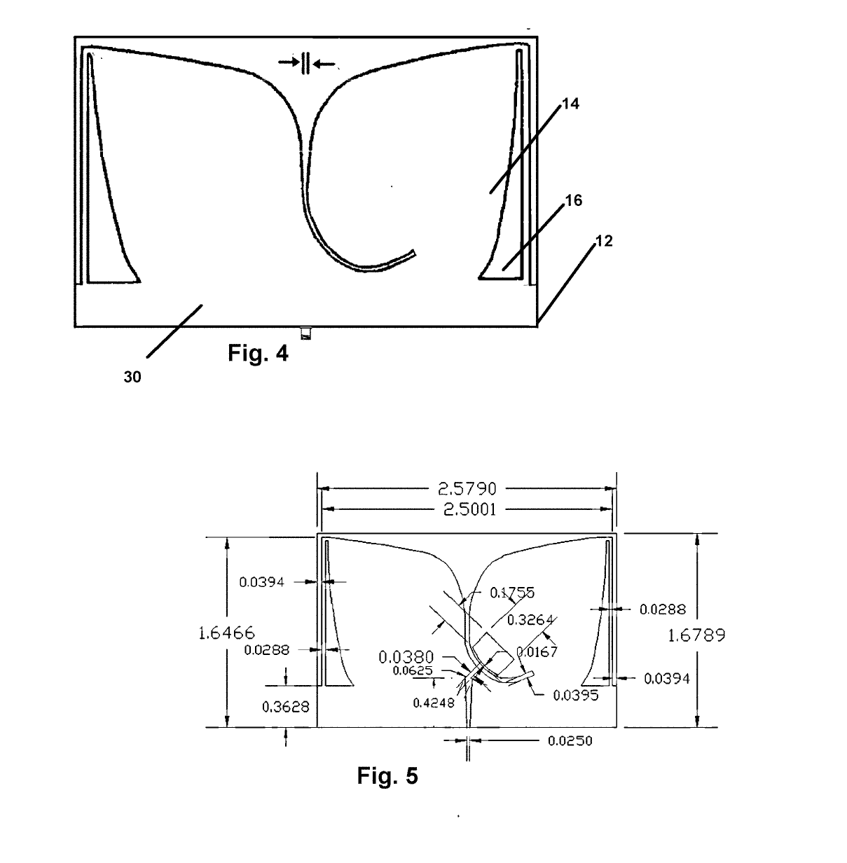

FIG. 4 shows another configuration of the wideband high gain dielectric notch antenna 12 element employable with the ground plane configurations herein, which has an overall shorter extension portion 30 and shorter length than that of FIGS. 1-3. While as noted this mode of the dielectric notch antenna 12 element has improved transmission and reception performance when paired with a ground plane 40 as shown in FIG. 6, for example, the mode of the dielectric notch antenna 12 element of FIGS. 1 and 2 at the ratios of height to width therein are preferred presently over this shorter version.

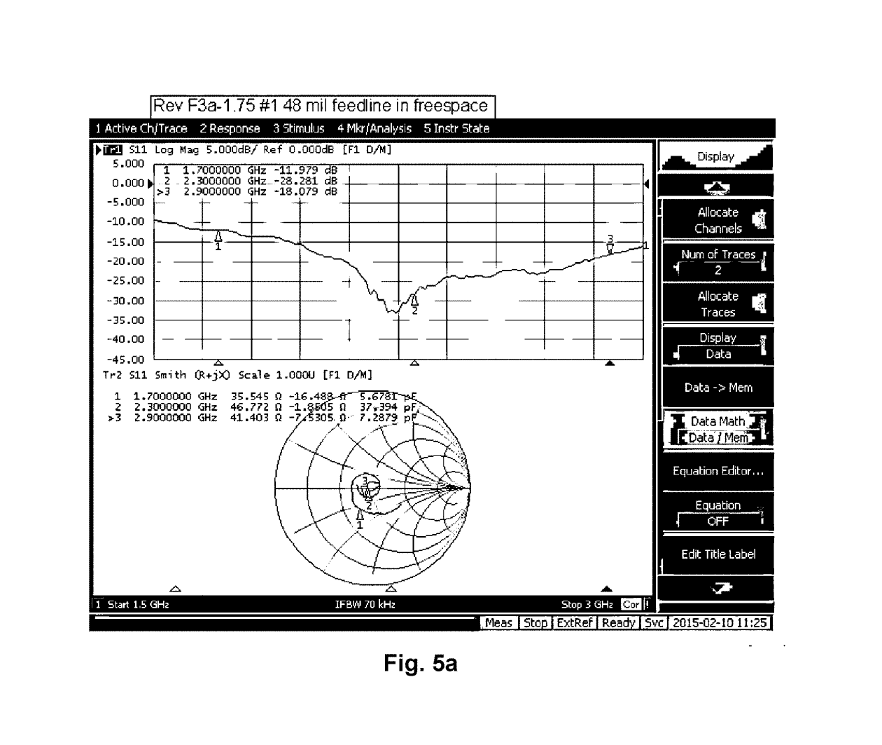

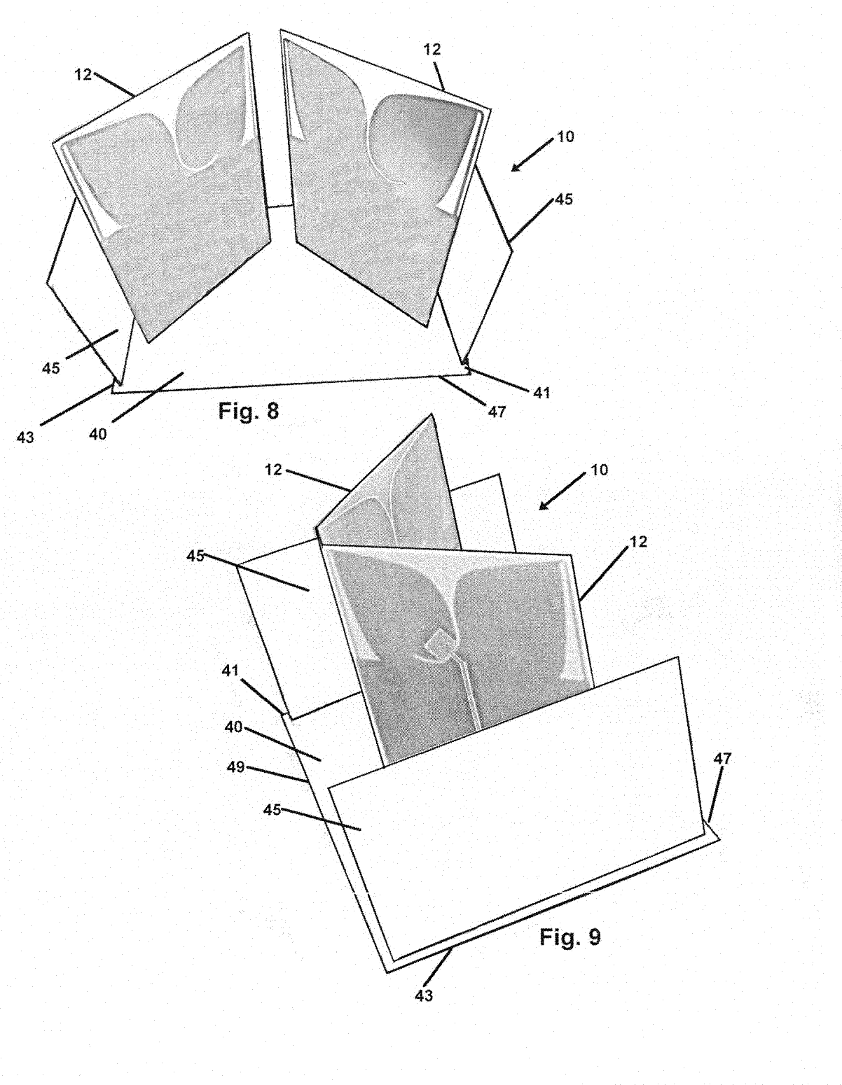

FIG. 5 shows some preferred dimensions of the dielectric notch antenna 12 element of FIG. 4, which when employed with the ground plane 40 configurations shown in FIGS. 6 and 8-9 will still benefit from enhanced performance, provided by the angled positioning of the pair of dielectric notch antennas 12 on the ground plane 40 which is further enhanced by the inclusion of the vertical ground plane sidewalls 45 shown in the configurations of FIGS. 8-9.

As noted, shown in FIG. 5a is a chart indicating the baseline measured return and loss of testing of a single dielectric notch antenna 12 element as configured in the noted ratios of FIGS. 1-2. FIG. 5a further shows the measured Return Loss and Smith Chart for the single dielectric notch antenna 12 in free space in the 1.7-2.9 Ghz range and shows what can be considered good results except for at the edges of the frequency coverage.

In FIG. 6 is shown a plurality of the dielectric notch antennas 12 of FIGS. 1-2 and configured in the ratios as to width and height noted in FIG. 3, electrically engaged to and extending substantially perpendicular from, a horizontally disposed planar ground plane 40. The dielectric notch antenna 12 elements are positioned and extend in planes normal to the plane of the horizontal ground plane 40. The ground plane 40 is shown as rectangular having a first end 41 and second end 43 and having a first side edge 47 and a second side edge 49 running therebetween. Also, both dielectric notch antenna 12 elements, so engaged, extend along imaginary lines at angles relative to each other shown in FIG. 11.

As noted earlier, the formed array in this FIG. 6, will provide a significant improvement in the radiation and reception of the dielectric notch antennas 12 or elements, without the inclusion of vertical ground plane 45 sidewalls extending in planes normal to the plane of the ground plane 40. However, a significant improvement in performance is achieved with the inclusion of both sidewalls or vertical ground plane 45 sidewalls extending from opposing side edges of the ground plane 40, which are also formed of conductive material such as copper, of which the ground plane 40 is also formed. The configuration of FIGS. 8-9 would be preferable where maximum performance is desirable.

The improvement with the ground plane 40 alone added, can be discerned in FIG. 7, which is a chart showing measured return and loss of testing of the device in the configuration of FIG. 6. The chart shows the signal improvement over the free form mode of the device depicted in FIG. 5a, which is provided by the single horizontal ground plane 40.

FIGS. 8-9 depicts a plurality of the dielectric notch antenna 12 elements of FIG. 12 electrically engaged with and extending substantially perpendicular from, a planar ground plane 40 formed of conductive material. The dielectric notch antenna 12 elements, extend along respective imaginary first and second lines in this engagement to the ground plane 40, which in a preferred mode run substantially perpendicular to each other. Also shown in FIGS. 8-9 are the conductive perpendicular vertical ground plane 45 sidewalls extending from the horizontal ground plane 40 at angles normal thereto.

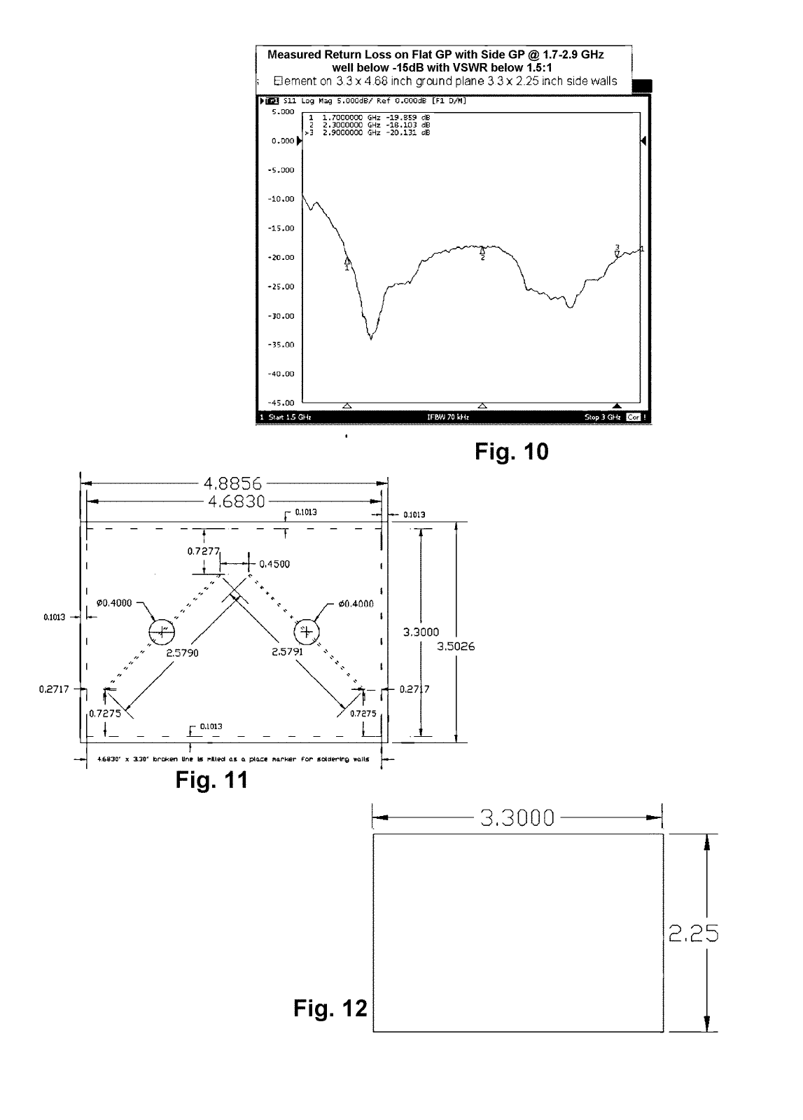

FIG. 10 is a chart showing measured return and loss of testing of a single dielectric notch antenna 12 or element of FIGS. 1-2 as configured with both a horizontal ground plane 40 and vertical ground planes 45, in FIGS. 8-9. The chart depicts the improved measured Return Loss and Smith Chart in the 1.7-2.9 Ghz range, and shows the improved performance the inclusion of the vertical ground planes 45 provides over results shown in the chart of FIG. 7.

Depicted in FIG. 11 is an overhead perspective view showing the angled positioning of the antenna 12 elements and their relative angle to each other rendered in FIGS. 8-9. Also shown is the positioning of the dielectric notch antennas 12 upon the vertical ground plane 45, and the size of the conductive material forming the horizontal ground plane 40 in this preferred mode.

Finally, as noted, in FIG. 12 is depicted current preferred dimensions of the optional vertical ground planes 45 provided by sidewalls shown in FIGS. 4-6. As noted the sidewalls defining the vertical ground planes 45 are formed of conductive material in an electric engagement with the horizontal ground plane 40. The planes of the vertical ground planes 45 run normal to the plane of the ground plane 40 and they are positioned adjacent the two angled dielectric notched antennas 12 engaged with the ground plane 40 as shown in FIG. 6, and depicted in FIGS. 4-5.

The conductive sidewalls forming these vertical ground planes 45 as noted, extend a distance from engagements at or adjacent opposing side edges of the planar horizontal ground plane 40, a distance between 50 to 70 percent the distance of extension of the length of the dielectric notch antenna 12 or radiator element from the horizontal ground plane 40, to the distal end 23 or 25, of one lobe 20 or 22 respectively. A height of the sidewalls between 60 to 70 percent of this height of the dielectric notch antenna 12 or element is particularly favored.

While all of the fundamental characteristics and features of the broadband dual linear cross polarization antenna invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A broadband dual linear cross polarization antenna comprising:
a horizontally disposed ground plane having a first end and having a second end opposite said first end, and having a first side edge running between said first end and said second end, and a second side edge opposite said first side edge;
said horizontally disposed ground plane having a first surface formed of a conductive layer and having a second surface opposite said first surface;
a first dielectric notch antenna formed by conductive material positioned upon a planar dielectric substrate;
a second dielectric notch antenna formed by conductive material positioned upon a planar dielectric substrate;
each of said first and second dielectric notch antennas having a gap in said conductive material upon said substrate, said gap extending from a widest point adjacent a first side edge of said dielectric substrate and in-between a first lobe and a second lobe formed of said conductive material, and declining in size from said widest point to a narrowest point;
each of said first and second dielectric notch antennas having said conductive material extending to a respective second side edge opposite a respective said first side edge thereof;
said first dielectric notch antenna extending vertically from an engagement of said second side edge thereof to said conductive layer of said horizontally disposed ground plane, along a first imaginary line; and
said second dielectric notch antenna extending vertically from an engagement of said second side edge thereof to said conductive layer of said horizontally disposed ground plane, along a second imaginary line, to said conductive layer of said horizontally disposed ground plane.

2. The broadband dual linear cross polarization antenna of claim 1, additionally comprising:
each of said first dielectric notch antenna and said second dielectric notch antenna having a respective connector engaged to a respective feed line thereof; and
each of said respective connecters projecting away from said second surface of said horizontally disposed ground plane.

3. The broadband dual linear cross polarization antenna of claim 1, additionally comprising:
said first imaginary line running perpendicular to said second imaginary line.

4. The broadband dual linear cross polarization antenna of claim 2, additionally comprising:
said first imaginary line running perpendicular to said second imaginary line.

5. The broadband dual linear cross polarization antenna of claim 1, additionally comprising:
a first vertical ground plane extending to a distal edge from an engagement of a first edge with said conductive layer of said horizontally disposed ground plane;
said engagement of said first edge of said first vertical ground plane being at or adjacent said first end of said horizontally disposed ground plane.
a second vertical ground plane extending to a distal edge from an engagement of a first edge thereof with said conductive layer of said horizontally disposed ground plane; and
said engagement of said first edge of said second vertical ground plane being at or adjacent said second end of said horizontally disposed ground plane.

6. The broadband dual linear cross polarization antenna of claim 2, additionally comprising:
a first vertical ground plane extending to a distal edge from an engagement of a first edge with said conductive layer of said horizontally disposed ground plane;
said engagement of said first edge of said first vertical ground plane being at or adjacent said first end of said horizontally disposed ground plane.
a second vertical ground plane extending to a distal edge from an engagement of a first edge thereof with said conductive layer of said horizontally disposed ground plane; and
said engagement of said first edge of said second vertical ground plane being at or adjacent said second end of said horizontally disposed ground plane.

7. The broadband dual linear cross polarization antenna of claim 3, additionally comprising:
a first vertical ground plane extending to a distal edge from an engagement of a first edge with said conductive layer of said horizontally disposed ground plane;
said engagement of said first edge of said first vertical ground plane being at or adjacent said first end of said horizontally disposed ground plane.
a second vertical ground plane extending to a distal edge from an engagement of a first edge thereof with said conductive layer of said horizontally disposed ground plane; and
said engagement of said first edge of said second vertical ground plane being at or adjacent said second end of said horizontally disposed ground plane.

8. The broadband dual linear cross polarization antenna of claim 4, additionally comprising:
a first vertical ground plane extending to a distal edge from an engagement of a first edge with said conductive layer of said horizontally disposed ground plane;
said engagement of said first edge of said first vertical ground plane being at or adjacent said first end of said horizontally disposed ground plane.
a second vertical ground plane extending to a distal edge from an engagement of a first edge thereof with said conductive layer of said horizontally disposed ground plane; and
said engagement of said first edge of said second vertical ground plane being at or adjacent said second end of said horizontally disposed ground plane.
